(19) United States
(12) Patent Application Publication
(10) Pub. No.: US 2005/0022208 A1
(43) Pub. Date: Jan. 27, 2005

(54) Corba gateway

(76) Inventors: Daniel Roy Bolar, Citrus Heights, CA (US); Anuj Srivastava, Phoenix, AZ (US); Fazhong Deng, Davis, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/625,611

(22) Filed: Jul. 24, 2003

(51) Int. Cl. G06F 15/173

(52) U.S. Cl. 719/315; 719/330; 709/223

(57) ABSTRACT

A Common Object Request Broker Architecture (CORBA) software gateway includes at least one of a scheme of invoking remote CORBA operations via a Network Management System (NMS) rule language and a scheme of remote invocation of NMS rules via a CORBA interface.

### BACKGROUND OF THE INVENTION

1. Field of the Invention

The present invention relates generally to network management systems, and more specifically, to a network management system that utilizes a Common Object Request Broker Architecture (CORBA) gateway.

2. Description of the Related Art

An Object Management Group (OMG) was formed in 1989 to develop a Common Object Request Broker Architecture (CORBA), which is a standard architecture for distributed object systems. CORBA has undergone numerous changes as different aspects were needed. CORBA allows a distributed, heterogeneous collection of objects to interoperate. Basically, CORBA provides a framework for a request for services of a distributed object. The services that an object provides are set forth by the object's interface, which is defined in the Interface Definition Language (IDL), a language developed by the OMG. Distributed objects are identified by object references that have IDL interface types.

CORBA consists of four basic parts: an Object Request Broker (ORB); object services; common facilities; and application and domain interfaces.

Client-server and object concepts are central to CORBA. In CORBA space, the object is an independent component, i.e., is a part of a program code that has an advanced interface, is not itself an application, may become a subject for sale and purchase in the software market, may be utilized in ways unforeseen by its programmer, and does not depend on the address space, the network protocol, algorithmic languages, an operating system or a specific infrastructure.

The components support inheritance, polymorphism, and encapsulation. Each component provides a certain type of service such as access to a database, access to a business account, and the like.

Interface Definition Language (IDL) is a high level language developed by OMG that describes CORBA components and other ORB components. IDL contains descriptions, declarations, passive definitions of attributes, parental classes, types of supported events, methods, basic and compound types of the data, and methods for processing errors. However, IDL has no direct functionality. In essence, IDL describes interfaces in a manner similar to how classes describe interfaces in C++. Each interface defines operations that may be requested by clients, and that are carried out using IDL and CORBA. IDL syntax is a subset of C++ with additional keywords in order to support distributed concepts. IDL compilers compile a variety of different programming languages.

In CORBA, a client obtains an object reference to a CORBA server object and creates a proxy object. The client calls the operations on the proxy object reference to invoke operations of the server, and the object reference is typed by an interface. An ORB delivers the request to the object and returns results to the client. Thus, the ORB is the distributed service that implements the request to the remote object. The ORB locates the remote object on the network, communicates the request to the object, and waits for the results. When the results are available, the ORB communicates the results to the client. The ORB is location transparent, i.e., the same request mechanism is used by the client and the CORBA object, and is not dependent on the location of the object. Also, the client may issue the request in one programming language, and the CORBA object may be implemented in another programming language.

Interoperability is provided by using Internet Inter-ORB Protocol (IIOP) that allows clients using a CORBA product from one vendor to communicate with objects using a CORBA product from another vendor. IIOP allows different Application Program Interfaces (APIs) to interoperate with each other across the Internet or any TCP/IP (a common Internet protocol) implementation, as well as with programs written to the CORBA API.

Thus, the interface of CORBA provides a standard definition of a set of distributed services for intermediate software that support integration and interoperation of distributed objects, such as providing for both static and dynamic methods of a call.

Typical object-oriented network management systems and operations support systems may have a framework that provides a platform for the creation of a network management system and operation support system for very complex Wide Area Networks (WANs). Each element, device and database may be managed as a separate object, but in the past, has required specific customization for each managed object. That is, each element, device and other managed object has required a specific set of rules to be suited to the nature of its object, its specific hardware and software, together with the business practices of the company.

Thus, there is a need for a flexible object-oriented network management system and operations support system gateway framework that automatically facilitates communication and integration with network devices that use external processes.

### SUMMARY OF THE INVENTION

Aspects of the invention will be set forth in part in the description which follows and, in part, will be obvious from the description, or may be learned by practice of the invention.

It is an aspect of the present invention to provide a Common Object Request Broker Architecture (CORBA) gateway, comprising a CORBA gateway translator that compares information sent between the CORBA gateway and a remote application with predetermined rules set for determining a subsequent action to be taken and executes predetermined rules to obtain the subsequent action, and at least one of: a CORBA server object that facilitates invoking operations in the CORBA gateway by the remote application; and a CORBA client proxy object that facilitates interactively invoking operations in the remote application by the CORBA gateway.

In a further aspect, in the CORBA gateway, the CORBA gateway translator includes a Dynamic Skeleton Interface (DSI), that, in an inbound call functionality, includes software that implements an Interface Definition Language (IDL) Interface without compiling in a server code generated by an IDL compiler to provide an object-oriented network management system and operations support system translation of the information received in accordance with at least one of an object-oriented network management system and operations support system Method Definitions and an object-oriented network management system and operations support system Management Information Model (MIM); and a rule engine, coupled to the DSI, to utilize an object-oriented network management system and operations support system translation to invoke an object-oriented network management system and operations support system rules in accordance with the object-oriented network management system and operations support system translation.

In another aspect, in the CORBA gateway, the CORBA gateway translator includes the rule engine, that, in a outbound calling functionality, uses the information received to generate a CORBA request in accordance with at least one of an object-oriented network management system and operations support system Method Definitions and an object-oriented network management system and operations support system Management Information Model (MIM); and a Dynamic Invocation Interface (DII), coupled to the rule engine, to invoke the CORBA request in a remote CORBA server object without compiling in a client code generated by an Interface Definition Language (IDL) compiler.

In another aspect, the CORBA gateway further includes an Interface Repository (IFR), coupled to the DII, to determine, programmatically, data types and operations defined by a third party IDL.

In one aspect, a network management support interface that automatically integrates operations utilizing a Common Object Request Broker Architecture (CORBA) protocol is provided, the interface comprising a system rule engine that receives and processes events coming from a CORBA gateway; and a CORBA gateway having a gateway rule engine to connect one of: connect a CORBA proxy object of the CORBA gateway to a CORBA server object of a device; and connect a CORBA proxy object of a device to a CORBA server object of the CORBA gateway. Thus, a server object in the gateway publishes its object reference via a file, a name service or by the object reference is provided by an operation of another server object. A proxy then uses the published object reference to connect to the server object in the gateway.

In another aspect, a Common Object Request Broker Architecture (CORBA) gateway in a network management support system automatically integrates operations in the gateway, the CORBA gateway comprising: a rule engine; an Interface Repository (IFR) to determine, programmatically, data types and operations defined in a third party Interface Definition Language (IDL); and a CORBA translator, coupled to the rule engine and the IFR, to translate the data types and operations into an object-oriented network management system and operations support system and generate a CORBA request on a remote CORBA object.

In another aspect, a computer-readable medium has computer-executable instructions stored thereon, wherein the computer-executable instructions include using a CORBA software gateway to invoke operations on a remote CORBA object; and using the CORBA software gateway to facilitate remote invocation of network management system rules via a CORBA interface.

In one aspect, the computer-readable medium implements a CORBA software gateway to invoke operations on a remote CORBA object by processing at least one of: a resulting return value, an out argument, and an exception.

In another aspect, the computer-readable medium implements the CORBA software gateway to facilitate remote invocation of network management system rules via a CORBA interface by setting time out values to a predetermined value after which an outbound request is deemed to have failed.

In one aspect, the computer-readable medium has computer-executable instructions for a rule writer stored thereon to make outbound CORBA calls using a CORBA gateway, wherein the computer-executable instructions include identifying a remote server object upon which an operation is to be invoked; obtaining an object reference to the server object; and creating a client side proxy object.

In another aspect, the computer-readable medium further comprises computer- executable instructions including informing the CORBA gateway that a connection to the server object, taking a form of a proxy object, is to be cached; instructing operators to provide access to and control the cache of proxy objects; naming the operation to be invoked on the server object; identifying an object-oriented network management system and operations support system attribute in which a return value is to be placed; setting attribute values to be passed to the operation as input arguments and identifying object-oriented network management system and operations support system attribute values that output argument values are to be placed in; identifying, if an exception occurs, an object-oriented network management system and operations support system attribute value that exception date is to be placed in; invoking the operation of a remote COBRA server object and processing at least one of resulting return values, out arguments and exceptions returned by the operation; and where desired, setting a predetermined timeout value.

In another aspect, the computer-readable medium further comprises, before the CORBA gateway invokes the CORBA object, computer-executable instructions including one of: obtaining a reference to the object; and associating resolved object references with a string key value that is reusable.

In one aspect, the computer-readable medium further comprises computer-executable instructions including one of: implementing a Least Recently Used (LRU) scheme to keep a number of cached objects under a predetermined count; and freezing proxy objects in the cache.

In another aspect, the computer-readable medium further comprises computer- executable instructions including one of: using an object-oriented network management system and operations support system attribute that controls how an object reference is managed by a object cache; and mapping CORBA operations to an object-oriented network management system and operations support system rule method that is then called from gateway analysis rules.

In one aspect, the computer-readable medium further comprises computer-executable instructions including one of: declaring an object-oriented network management system and operations support system rule method using a method name and, where desired, formal parameters; and mapping a CORBA defined operation into an object-oriented network management system and operations support system only once.

In another aspect, the computer-readable medium includes computer-executable instructions to access, by the CORBA gateway mapping process, the object-oriented network management system and operations support system database directly, and the object-oriented network management system and operations support system is one of: operating and not operating before the mapping process is executed; and use a CORBA Interface Repository (IFR) to determine a CORBA operation and data types and exceptions used by the CORBA operation.

In one aspect, the computer-readable medium further comprises computer-executable instructions including at least one of: creating, via CORBA gateway IDL mapping, Abstract Syntax Notation (ASN) data types in an object-oriented network management system and operations support system database to be mapped to and from CORBA data types by the CORBA gateway; encoding information required to map the data types in the data type names stored in the object-oriented network management system and operations support system database; creating attribute definitions in the object-oriented network management system and operations support system database that are used for operation return values, arguments and exceptions; creating a rule method for each mapped IDL operation; encoding an IDL operation name in the rule method name; and encoding information required to map a rule method to a CORBA operation in the method name and the attribute names of formal parameters of the method.

In another aspect, a computer-readable medium having computer-executable instructions stored thereon to facilitate making inbound CORBA calls using a CORBA gateway, includes computer-executable instructions that include at least one of: creating server objects, wherein a single server object represents a single IDL interface; creating multiple server objects that implement different interfaces; creating multiple server objects to implement a same interface; accessing a previously created server object; deleting the previously created server object; disabling the previously created server object from accepting inbound calls; re-enabling a disabled server object; providing server object references to external processes; associating an inbound operation call to a rule set which is executed when the CORBA operation is invoked; setting an attribute value and send the attribute value back to a client as one of: a return, an out, and an exception value; and processing input arguments to the CORBA operation as object-oriented network management system and operations support system attribute values. An inbound call is made by a remote proxy. A rule writer writes rules to implement the operations invoked via the inbound call.

In another aspect, the computer-readable medium comprises computer-executable instructions that further include creating a server object and a reference to the object by an external client before allowing the client to invoke operations on the object.

In one aspect, a computer-readable medium having computer-executable instructions stored thereon to facilitate making inbound CORBA calls using a CORBA gateway, comprises computer-executable instructions that include at least one of: creating a server side object and making the server side object available to a remote client via the CORBA gateway of the present invention; and calling a rule method when an operation on the object is invoked by the remote client so that the rules process attributes that input arguments were mapped into; setting an exception attribute to indicate one of: the absence and the existence of an exception; and if no exception is indicated, setting a value of a return value and sending a reply to the remote client.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an embodiment of a CORBA Gateway Runtime Process in accordance with an embodiment of the present invention.

FIG. 2 is a block diagram of a CORBA gateway in accordance with an embodiment of the present invention.

### DETAILED DESCRIPTION OF THE EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

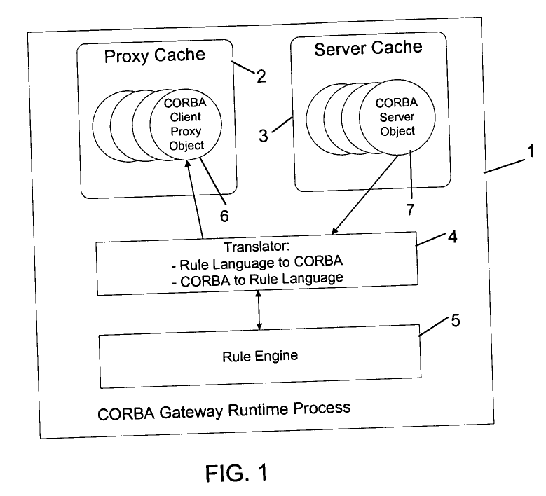

FIG. 1 is a block diagram of an embodiment of a Common Object Request Broker Architecture (CORBA) gateway 1 in accordance with the present invention. As used herein, a CORBA architecture is an architecture that enables pieces of programs, called objects, to communicate with one another regardless of the programming language in which the objects are written or the operating system in which the objects are being used. A CORBA server object implements operations that refer to the CORBA Interface Definition Language (IDL). A CORBA client obtains an object reference to a CORBA server object and creates a proxy client object. Operations of the server object are invoked when the client calls the operations on the proxy client object.

In a conventional object-oriented network management system and operations support system, a gateway is a software component that communicates with a network device or a managed object manager. When the gateway receives messages from the device such as alarms and performance data, the gateway filters the messages using rules, analyzes the messages and passes relevant messages to a rule engine for an object-oriented network management system and operations support system. The gateway also uses dialogs to execute commands to the device interactively and to identify responses from the device. Gateways use the dialogs to retrieve data and to act on the device.

The CORBA gateway, according to an embodiment of the present invention, provides a software component to an object-oriented network management system and operations support system that communicates with a network devices and processes (which may be internal or external) through CORBA interfaces. The CORBA gateway includes CORBA server objects that enable the connected device or process invoke operations in the CORBA gateway. The operation calls are mapped to the object-oriented network management system and operations support system rules and the arguments of the operation are mapped to the object-oriented network management system and operations support system attributes. The rules analyze the attribute values and pass relevant messages to a rule engine for the object-oriented network management system and operations support system. The CORBA gateway may also include a CORBA client proxy object. The CORBA client proxy object is connected to a server object in the device or process. Specialized mapping enables the object-oriented network management system and operations support system rules to invoke operations implemented in the device or process interactively using the object-oriented network management system and operations support system attributes as arguments. Thus, not only may the CORBA gateway of the present invention communicate with network devices, users may write specialized CORBA clients and servers that use the CORBA gateway of the present invention to integrate external processes with the object-oriented network management system and operations support system, thus monitoring and controlling devices and processes.

FIG. 1 is a block diagram of an embodiment of a CORBA Gateway Runtime Process 1 in accordance with an embodiment of the present invention. The CORBA Gateway Runtime Process 1 includes a rule engine 5 coupled to a translator 4 that translates rule language to CORBA and CORBA to rule language for the proxy cache 2 and the server cache 3, respectively. The proxy cache 2 includes a plurality of CORBA client proxy objects, and the server cache 3 includes a plurality of CORBA server objects. For example, IDEAS™ (a trademark of Agilent Technologies) is a rule engine of the NetExpert system that may be utilized.

Thus, in one embodiment, the CORBA Gateway Runtime Process 1 comprises a translator that compares information from the gateway to a remote application and/or to the gateway from a remote application with predetermined rules set for determining a subsequent action to be taken and executes rules in accordance with the information and at least one of a CORBA server object 7 and a CORBA client proxy object 6. Throughout the specification, a remote application refers to a remote device or remote process. That is, separate CORBA gateways may each include a CORBA server object 7 and a CORBA client proxy object 6, or both the CORBA server object 7 and the CORBA client proxy object 6 may be implemented in a single CORBAGateway Runtime Process 1. The CORBA server object 7 in the CORBA Gateway Runtime Process 1 facilitates invoking operations in the CORBA gateway by a remote application (inbound calling functionality), and the CORBA client proxy object 6 in the CORBA gateway facilitates interactively invoking operations in the remote application (outbound calling functionality) by the CORBA gateway.

The CORBA gateway may utilize many functions that are implemented by an object-oriented network management system and operations support system gateway, for example, communication via InterProcess Message Handling (IPMH), startup, shutdown and reinitialization, identification and parse capabilities, using an integrated rule engine, using Extended Operator (EO) capabilities, communicating with a system rule engine (not shown), for example, a system rule engine for NetExpert (IDEAS™), and using dialogs.

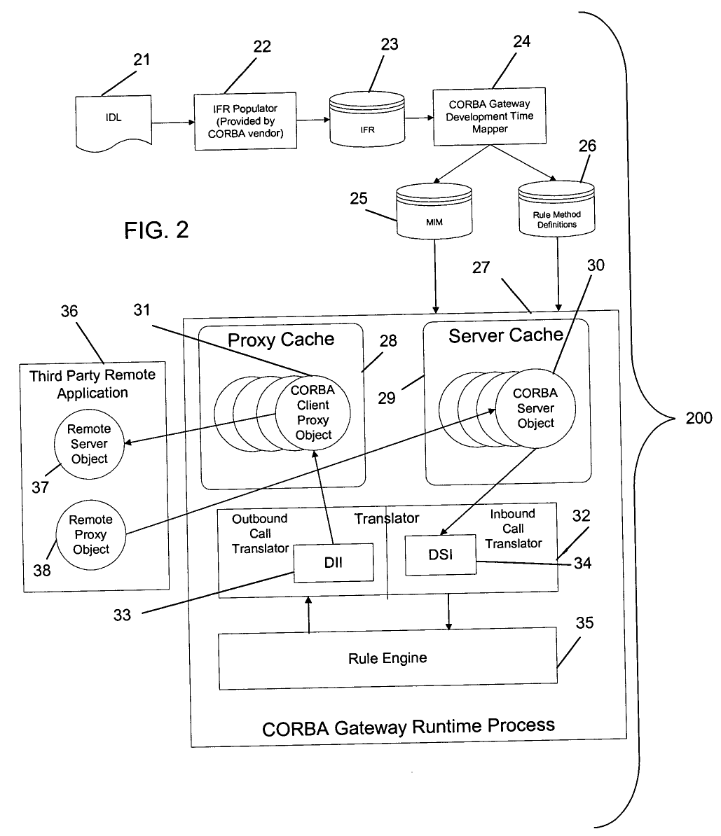

As shown in the embodiment of a CORGA gateway in FIG. 2, the CORBA gateway 200 may invoke inbound or outbound call functionality. In an embodiment of the present invention, the CORBA gateway 200 includes a CORBA gateway translator 32 coupled to a CORBA server object 30. The CORBA gateway translator 32 comprises a Dynamic Skeleton Interface (DSI) 34 coupled to a rule engine 35. The CORBA server object 30 is connected to a CORBA client proxy object (not shown) in a remote device or process. The CORBA gateway 200 invokes remote operations using an Extended Operator (EO). The EO may also be loaded by another gateway to make an outgoing CORBA call. When a mapped interface is activated by the EO, the CORBA client proxy object 31 obtains references into the CORBA gateway 200 and call operations. A call on the interface results in execution of rules since the CORBA gateway 200 acts as a server via a CORBA server object 30 using the DSI 34 that provides an object-oriented network management system and operations support system translation to the rule engine 35 of the CORBA gateway in accordance with at least one of the object-oriented network management system and operations support system Method Definitions Database 26 and an object-oriented network management system and operations support system Management Information Model (MIM) Database 25, and the rule engine 35 executes the rules. A CORBA Interface Repository (IFR) 23 may be used by the CORBA gateway mapping process to obtain details of data types and operations defined in an IDL file 21.

The CORBA gateway 200 typically comprises two components: a development time mapper 24 and a runtime translator (labeled in FIG. 2 as “Translator”) 32. The development time mapper 24 obtains data types and operation definitions from the CORBA IFR (labeled “IFR” in FIG. 2) 23 and translates the data types and operation definitions obtained into data types and definitions that are written directly to an NMS/OSS database (such as “NetExpert MIM” 25 and “NetExpert Method Definitions” 26 in FIG. 2) to provide mapping information. The development time mapper 24 is substantially independent of the CORBA Gateway Runtime Process 27, and reads from the IFR 23 and writes to the NMS/OSS database 25, 26. The development time mapper 24 generates a portion of the rule language in the NMS/OSS database 25, 26, which is executable by the CORBA Gateway Runtime Process 27.

The mapping information is encoded into MIM data type names, attribute names, rule method names, and rule method formal parameters.

After mapping, rules are written by a developer to perform at least one of: connecting to a remote server object, making outbound calls and processing results; and implementing operations of a server, creating a server object and publishing the server object's object references.

The runtime translator 32 is located in the CORBA Gateway Runtime Process 27. The runtime translator 32 translates NMS/OSS rule operations into CORBA operations and vice-versa. For enhanced performance, the runtime translator 32 does not use the CORBA IFR 23. The information required to do the translation is encoded into MIM data type definitions, rule method definitions and rule method formal parameter definitions that were written to the NMS/OSS database by the development time mapper 24. The MIM and rule method data is read by the CORBA Gateway Runtime Process 27 at startup and cached, adding additional performance by eliminating the need to go to a database when doing runtime translations.

The CORBA gateway 200 may invoke outbound call functionality in accordance with an embodiment of the present invention. The CORBA gateway 200 may include the CORBA gateway translator 32 coupled to the CORBA client proxy object 31. The CORBA gateway translator 32 comprises a Dynamic Invocation Interface (DII) 33 coupled to the rule engine. The rule engine 35, in a outbound calling functionality, uses the information received and generates a CORBA request in accordance with at least one of an object-oriented network management system and operations support system Method Definitions Database 26 and an object-oriented network management system and operations support system Management Information Model (MIM) Database 25. The Dynamic Invocation Interface (DIl) 33, coupled to the rule engine 35,utilizes the CORBA client proxy object 31 to invoke the CORBA request in a remote CORBA server object (not shown) of a remote application without compiling in a client code generated by an Interface Definition Language (IDL) compiler. The DII 33 does not utilize the IFR. The information used by the CORBA Gateway 200 to create a CORBA outbound call via DII 33 is encoded in the data type names, rule method names and rule method formal parameter names that the mapping process created in the MIM and rule method database. The information obtained form the IFR that describes a CORBA operation, and the data types used in the operation, is substantially duplicated in the MIM and rule method database by the mapper.

Where desired, the DII 33 and the DSI 34 of the CORBA gateway translator 32 may be combined into a single unit.

In one embodiment of the present invention, illustrated in FIG. 2, a Common Object Request Broker Architecture (CORBA) gateway 200 in a network management support system wherein the CORBA gateway 200 automatically integrates operations in the gateway may comprise: a (gateway) rule engine 35; and a CORBA translator 32, coupled to the (gateway) rule engine 35, to translate the data types and operations into the object-oriented network management system and operations support system and generate a CORBA request on a remote CORBA object.

A Third Party Remote Application 36 comprises either a client object (shown as remote proxy object 38) that makes inbound calls to server objects in the CORBA Gateway, a server object (shown as remote server object 37) that the CORBA Gateway proxy objects make an outbound call to, or both. The terms “proxy object” and “client object” are synonymous. When the third party vendor implements the remote application, a same IDL that is used in the CORBA Gateway mapping is used in the development of the application.

In order to make outbound CORBA calls using the CORBA gateway of the present invention, a rule writer has the following capabilities. When the rule writer identifies a remote server object upon which an operation is to be invoked, an object reference to the server object is obtained and a client side proxy object is created. The rule writer informs the CORBA gateway that a connection to a server object, which will take the form of a proxy object, is to be cached for later use. The rule write requires operators that provide access to and control the cache of proxy objects. The operation is given a name so that the rule writer may identify the name of the operation to be invoked on the server object. An object-oriented network management system and operations support system attribute value is identified in which the return value is to be placed. The rule writer sets the object-oriented network management system and operations support system attribute values that are to be passed to the operation as input arguments and is capable of identifying an object-oriented network management system and operations support system attribute values that output argument values are to be placed in. If an operation call results in an exception, the rule writer can identify an object-oriented network management system and operations support system attribute value that exception data is to be placed in. Since all CORBA operations may potentially result in a CORBA System Exception, the rule writer has the capability of determining if such an exception occurred and if so, has access to the data for the exception. The rule writer has the ability to invoke the operation of a remote COBRA server object and is capable of processing resulting return values, out arguments or exceptions returned by an operation. The rule writer has the ability to set a timeout value to limit an amount of time an outbound request may take before it is deemed to have failed. Such a timeout results in a CORBA System Exception. The rule writer has the capability of invoking one-way or two-way CORBA operations.

Before a CORBA gateway invokes a CORBA object, a reference to the object must first be obtained. For example, a target object of a request may be identified in three ways: providing a path to a file that contains a stringified IOR of the object, providing a name that may be used to obtain an object reference from a CORBA Name Service, and providing a stringified IOR directly. A CORBA gateway provides a caching facility that allows resolved object references to the associated with a string key value. The object reference may then be reused in subsequent operation invocations by providing the key value, thus reducing the overhead of having to bind to a particular object multiple times when multiple operation invocations are to be performed.

In an embodiment of the outbound call functionality, the CORBA gateway object cache may implement a Least Recently Used (LRU) scheme to keep a number of cached objects under a predetermined count. Extended Operators (EOs) may be provided that give the rule writer the ability to set such a value. When a number of cached proxy objects in the cache reaches the predetermined count, the least recently used objects are released.

The object cache may also be selected to freeze proxy objects in the cache. That is, the object reference will not be swapped out by the LRU processing.

An object reference used for outbound calls is identified by using an object-oriented network management system and operations support system attribute that controls how the object reference is managed by the object cache. Typically, a type name indicating a function such as a key (identification), lookup, save freeze, timeout, or source is utilized to specify management of the attribute.

Operators may, for example, be utilized to set low and high water marks of the LRU processing, to look up an entry in the object cache, place an object identified into CORBA gateway's object cache with a key value, to resolve and place objects in the object cache without invoking operation of the object, to indicate if problems have occurred during object resolution, or to remove an object from the CORBA gateway's object cache.

In the outbound call functionality, CORBA operations are mapped to an object-oriented network management system and operations support system rule method that may then be called from gateway analysis rules. An object-oriented network management system and operations support system rule method may be declared using a method name and a list of zero or more formal parameters. Each formal parameter is identified using an object-oriented network management system and operations support system attribute name and a passing mechanism. A passing mechanism is either by value or by reference. Since the object-oriented network management system and operations support system rule method generally has no concept of a target object, a return value or exceptions, additional formal parameters are added to the rule method by the mapping process to identify target objects, return values and exceptions. The remainder of the method's parameters map to the in, out, and inout arguments of the CORBA operation.

Each argument in the IDL of a CORBA operation is mapped to the object-oriented network management system and operations support system attribute, which is then added to the formal parameters of the object-oriented network management system and operations support system rule method. In one embodiment, since three formal parameters are added for the target object, the return value and the exception, a first mapped argument of the CORBA operation appears as the fourth formal parameter of the object-oriented network management system and operations support system rule method.

Typically, a CORBA defined operation is mapped into the object-oriented network management system and operations support system only once. Thus, after mapping is completed, the operation is available to the object-oriented network management system and operations support system rule writers.

In one embodiment, the CORBA gateway mapping process accesses the object-oriented network management system and operations support system database directly, so that the an object-oriented network management system and operations support system need not be operating before the mapping process is executed.

The CORBA gateway IDL mapping creates Abstract Syntax Notation (ASN) data types in the object-oriented network management system and operations support system database that may be mapped to and from CORBA data types by the CORBA gateway, encodes information required to map the data types in the data type names stored in the object-oriented network management system and operations support system database, creates attribute definitions in the object-oriented network management system and operations support system database that are used for operation return values, arguments and exceptions, creates a rule method for each mapped IDL operation, encodes the IDL operation name in the rule method name, and encodes the information required to map a rule method to a CORBA operation in the method name and the attribute names of the method's formal parameters.

The CORBA gateway mapping process may use the CORBA Interface Repository (IFR) to determine a CORBA operation and data types and exceptions used by the operation. Typically, a CORBA vendor provides the IFR and a process to read and parse the IDL file and populates the IFR. When the IFR has been populated, the CORBA gateway process maps one or more CORBA operations into the object-oriented network management system and operations support system, thus creating the pseudo primitive data types and predefined CORBA gateway data types in the MIM, mapping the CORBA data types reference in the CORBA operation to the object-oriented network management system and operations support system data types, creating the attributes used as formal parameters in the object-oriented network management system and operations support system rule method, and mapping the CORBA operation to an object-oriented network management system and operations support system rule method.

In one embodiment, an object-oriented network management system and operations support system rule method is associated with an object-oriented network management system and operations support system class, wherein the class with which the method is associated with does not restrict where the method may be called from, but rather provides an additional level to the GUI lists that present method names in the rule editor.

When an inbound call functionality is implemented in the CORBA gateway of the present invention, a rule writer has the following capabilities. The rule writer may create server objects, wherein a single server object typically represents a single IDL interface. In addition to creating multiple server objects that implement different interfaces, the rule writer may create multiple server objects that implement the same interface. The rule writer may access a previously created server object and may delete a previously created server object. The rule writer may disable a previously created server object from accepting inbound calls and later re-enable the server object. The rule writer may provide server object references to external processes and may associate an inbound operation call to a rule set which is executed when the CORBA operation is invoked. The rule writer may set an attribute value that is then sent back to the client as a return value and may process input arguments to the CORBA operation as the object-oriented network management system and operations support system attribute values. In addition, the rule writer may set attribute values that are then sent back to the client as out arguments. Also, the rule writer may indicate an exception has occurred and set attribute values that are used to represent the exception's data.

To achieve the inbound call functionality set forth above, in an embodiment of the CORBA gateway of the present invention, a server object is created and a reference to the object is obtained by the external client before the client may invoke the operations on the object. Typically, the server object reference is identified via a naming service, an IOR file or an outbound call. For an outbound call, the rule writer typically obtains an attribute value that contains a stringified object reference of the server object and uses the attribute value as an argument in a CORBA gateway outbound call to register the object as a callback object with an external server, to register the object with an event service, to register the object with a notification service, or to register the object with a Name Service that is outside the environment in which the CORBA gateway runs.

The CORBA gateway of the present invention implements a cache that contains the server objects that have been created in the gateway. The process of creating a server object automatically places the object in the cache. Typically, a single entry in the cache represents a single server object. Generally, the entry contains a unique name of the object in the cache, the name of the interface, a reference to the object, a state (enabled/disabled) of the object, and statistics concerning the object (such as a creation timestamp, a number of times invoked, and the like). A server object is created by setting the values of a CORBA gateway generated attribute and executing a special operator. An object-oriented network management system and operations support system data type of the attribute may include a key, a module (name of the IDL module the interface the object represents was defined in), an interface (the name of the IDL interface the object implements), an optional value used to register the server with a name service, an optional value used to indicate the name of a file that a stringified IOR of the object will be written to, and a state (enabled/disabled).

The operator used to create a server object typically creates a server object that represents the specified interface, places the object in a cache with a specified key, optionally registers the object with a name service, optionally writes a stringified reference to the server object to a file, and makes the object available to accept requests if the state is enabled.

Typical server cache operators may locate the server object identified by key in the server cache and set the state an identified value, remove the server object identified by key from the server cache and release it, and locate the server object identified by key in the server cache and set an identified attribute to the stringified IOR of the object.

With respect to operation mapping, the server operations are mapped to an object-oriented network management system and operations support system rule method, and generally, the body of the method is left empty and is the responsibility of the rule writer to implement, the text -impl may be appended to the method name and to the parameters to the method, and a first parameter of the method is a string type and contains the server cache key of the object that the operation was invoked on, allowing multiple server objects in the CORBA gateway to implement the same interface and still distinguish in rules what object the operation was invoked on. Mapping of the CORBA operation return values, exceptions and arguments are mapped to the object-oriented network management system and operations support system data types and attributes in the same manner (except for the addition of -impl to the attribute names) as the mapping of the outbound calls.

Thus, the user may write gateway analysis rules to call a CORBA operation by setting the values of the CORBA gateway generated attributes used as parameters to the rule method that was created for the CORBA operation, call the rule method, check if an exception has occurred, and if no exception has occurred, process return values.

The mapping process for inbound calls is generally performed by a same program as the program used in outbound call mapping. Thus, as with outbound call mapping, the IDL that defines the operations is first added to the interface repository. Generally, the same options for mapping the operations for outbound call mapping are supported for inbound call mapping, and class mapping is available for inbound call mapping also.

Thus, for inbound CORBA calls using the CORBA gateway in accordance with an embodiment of the present invention, two different sets of rules are generally required. One set of rules creates the server side object and makes the server side object available to remote clients via the CORBA gateway of the present invention. The second set of rules are executed when an operation is invoked on the object by the remote client. Thus, for an inbound CORBA call, the CORBA gateway may call the rule method when a remote client invokes a CORBA operation, so that the rules process the attributes that the input arguments were mapped into. The rules then set the exception attribute to indicate the absence or existence of an exception. If no exception is indicted, the rules set the values of the return values (typically to return, out and inout arguments). Completion of the rule method causes the CORBA gateway to send the reply to the remote client.

Although a few embodiments of the present invention have been shown and described, it would be appreciated by those skilled in the art that changes may be made in this embodiment without departing from the principles and spirit of the invention, the scope of which is defined in the claims and their equivalents.

1. A Common Object Request Broker Architecture (CORBA) gateway, comprising:
a CORBA gateway translator that compares information sent between the CORBA gateway and a remote application with predetermined rules set for determining a subsequent action to be taken and executes the predetermined rules to obtain the subsequent action; and
at least one of:
a CORBA server object that facilitates invoking operations in the CORBA gateway by the remote application; and
a CORBA client proxy object that facilitates interactively invoking operations in the remote application by the CORBA gateway.

2. The CORBA gateway of claim 1, wherein the CORBA gateway translator includes:
a Dynamic Skeleton Interface (DSI), that, in an inbound call functionality, includes software that implements an Interface Definition Language (IDL) Interface without compiling in a server code generated by an IDL compiler to provide an object-oriented network management system and operations support system translation of the information received in accordance with at least one of an object-oriented network management system and operations support system Method Definitions and an object-oriented network management system and operations support system Management Information Model (MIM); and
a rule engine, coupled to the DSI, to utilize the an object-oriented network management system and operations support system translation to invoke an object-oriented network management system and operations support system rules in accordance with the object-oriented network management system and operations support system translation.

3. The CORBA gateway of claim 1, wherein the CORBA gateway translator includes:
a rule engine, that, in a outbound calling functionality, uses the information received to generate a CORBA request in accordance with at least one of an object-oriented network management system and operations support system Method Definitions and an object-oriented network management system and operations support system Management Information Model (MIM); and
a Dynamic Invocation Interface (DII), coupled to the rule engine, to invoke the CORBA request in a remote CORBA server object without compiling in a client code generated by an Interface Definition Language (IDL) compiler.

4. A network management support interface that automatically integrates operations utilizing a Common Object Request Broker Architecture (CORBA) protocol, the interface comprising:
a system rule engine that receives and processes events coming from a CORBA gateway; and
a CORBA gateway having a rule engine to connect one of:
connect a CORBA proxy object of the CORBA gateway to a CORBA server object of a device; and
connect a CORBA proxy object of a device to a CORBA server object of the CORBA gateway.

5. A Common Object Request Broker Architecture (CORBA) gateway in a network management support system, the CORBA gateway automatically integrating operations in the gateway, the CORBA gateway comprising:
a rule engine;
an Interface Repository (IFR) to determine, programmatically, data types and operations defined in a third party Interface Definition Language (IDL); and
a CORBA translator, coupled to the rule engine and the IFR, to translate the data types and operations into an object-oriented network management system and operations support system and generate a CORBA request on a remote CORBA object.

6. A computer-readable medium having computer-executable instructions stored thereon, wherein the computer-executable instructions include:
using a CORBA software gateway to invoke operations on a remote CORBA object; and
using the CORBA software gateway to facilitate remote invocation of network management system rules via a CORBA interface.

7. The computer-readable medium of claim 6, wherein using a CORBA software gateway to invoke operations on a remote CORBA object comprises:
processing at least one of: a resulting return value, an out argument, and an exception.

8. The computer-readable medium of claim 6, wherein using the CORBA software gateway to facilitate remote invocation of network management system rules via a CORBA interface comprises:
setting time out values to a predetermined value after which an outbound request is deemed to have failed.

9. A computer-readable medium having computer-executable instructions for a rule writer stored thereon to make outbound CORBA calls using a CORBA gateway, wherein the computer-executable instructions include:
identifying a remote server object upon which an operation is to be invoked;
obtaining an object reference to the server object; and
creating a client side proxy object.

10. The computer-readable medium of claim 9, further comprising computer-executable instructions including at least one of:
informing the CORBA gateway that a connection to the server object, taking a form of a proxy object, is to be cached;
instructing operators to provide access to and control the cache of proxy objects;
naming the operation to be invoked on the server object;
identifying an object-oriented network management system and operations support system attribute in which a return value is to be placed;
setting attribute values to be passed to the operation as input arguments and identifying object-oriented network management system and operations support system attribute values that output argument values are to be placed in;
identifying, if an exception occurs, an object-oriented network management system and operations support system attribute value that exception date is to be placed in;
invoking the operation of a remote COBRA server object and processing at least one of resulting return values, out arguments and exceptions returned by the operation; and
where desired, setting a predetermined timeout value.

11. The computer-readable medium of claim 9, further comprising, before the CORBA gateway invokes the CORBA object, computer-executable instructions including one of:
obtaining a reference to the object; and
associating resolved object references with a string key value that is reusable.

12. The computer-readable medium of claim 9, further comprising computer-executable instructions including one of:
implementing a Least Recently Used (LRU) scheme to keep a number of cached objects under a predetermined count; and
freezing proxy objects in the cache.

13. The computer-readable medium of claim 9, further comprising computer-executable instructions including one of:
using an object-oriented network management system and operations support system attribute that controls how an object reference is managed by a object cache; and
mapping CORBA operations to an object-oriented network management system and operations support system rule method that is then called from gateway analysis rules.

14. The computer-readable medium of claim 9, further comprising computer-executable instructions including one of:
declaring an object-oriented network management system and operations support system rule method using a method name and, where desired, formal parameters; and
mapping a CORBA defined operation into an object-oriented network management system and operations support system only once.

15. The computer-readable medium of claim 9, wherein one of:
accessing, by the CORBA gateway mapping process, the object-oriented network management system and operations support system database directly, and the object-oriented network management system and operations support system is one of: operating and not operating before the mapping process is executed; and
using a CORBA Interface Repository (IFR) to determine a CORBA operation and data types and exceptions used by the CORBA operation.

16. The computer-readable medium of claim 9, further comprising computer-executable instructions including at least one of:
creating, via CORBA gateway IDL mapping, Abstract Syntax Notation (ASN) data types in an object-oriented network management system and operations support system database to be mapped to and from CORBA data types by the CORBA gateway;
encoding information required to map the data types in the data type names stored in the object-oriented network management system and operations support system database;
creating attribute definitions in the object-oriented network management system and operations support system database that are used for operation return values, arguments and exceptions;
creating a rule method for each mapped IDL operation;
encoding an IDL operation name in the rule method name; and
encoding information required to map a rule method to a CORBA operation in the method name and the attribute names of formal parameters of the method.

17. A computer-readable medium having computer-executable instructions stored thereon to facilitate making inbound CORBA calls using a CORBA gateway, wherein the computer-executable instructions include at least one of:
creating server objects, wherein a single server object represents a single IDL interface;
creating multiple server objects that implement different interfaces;
creating multiple server objects to implement a same interface;
accessing a previously created server object;
deleting the previously created server object;
disabling the previously created server object from accepting inbound calls;
re-enabling a disabled server object;
providing server object references to external processes;
associating an inbound operation call to a rule set which is executed when the CORBA operation is invoked;
setting an attribute value and send the attribute value back to a client as one of: a return, an out, and an exception value; and
processing input arguments to the CORBA operation as object-oriented network management system and operations support system attribute values.

18. The computer-readable medium of claim 17, wherein the computer-executable instructions further include:
creating a server object and a reference to the object by an external client before allowing the client to invoke operations on the object.

19. A computer-readable medium having computer-executable instructions stored thereon to make inbound CORBA calls using a CORBA gateway, wherein the computer-executable instructions include at least one of:
creating a server side object and making the server side object available to a remote client via the CORBA gateway of the present invention; and
calling a rule method when an operation on the object is invoked by the remote client so that the rules process attributes that input arguments were mapped into;
setting an exception attribute to indicate one of: the absence and the existence of an exception; and
if no exception is indicated, setting a value of a return value and sending a reply to the remote client.

20. A CORBA gateway, comprising:
a development time mapper, to obtain data types and operation definitions from an Interface Repository and translate data types and operation definitions obtained into data types and definitions that are written directly to a predetermined database to provide mapping information; and
a runtime translator, to translate rule operations into CORBA operations and CORBA operations into rule operations utilizing the mapping information comprising at least one of encoded Management Information Model data type definitions, encoded rule method definitions and encoded rule method formal parameter definitions that were written to the predetermined database by the development time mapper, wherein the mapping information is read by the CORBA gateway at startup and cached.
